(19) United States
(12) Patent Application Publication
(10) Pub. No.: US 2019/0013720 A1
(43) Pub. Date: Jan. 10, 2019

(54) STATOR FOR ROTARY ELECTRIC MACHINE

(71) Applicant: HONDA MOTOR CO., LTD., Tokyo (JP)

(72) Inventor: Andrii PYDIN, Saitama (JP)

(73) Assignee: HONDA MOTOR CO., LTD., Tokyo (JP)

(21) Appl. No.: 16/028,971

(22) Filed: Jul. 6, 2018

(30) Foreign Application Priority Data
Jul. 10, 2017 (JP) 2017-134844

(51) Int. Cl. H02K 15/085; H02K 1/16; H02K 3/12; H02K 3/28; H02K 15/02; H02K 15/12

(52) U.S. Cl. CPC H02K 15/085; H02K 1/16; H02K 15/12; H02K 3/28; H02K 15/024; H02K 3/12

(57) ABSTRACT

Provided is a method of manufacturing a stator for a rotary electric machine that can easily form the stator using coil segments. A first coil segment is moved outward in a radial direction after being arranged inside a stator core and is inserted into an outer diameter side of a slot, and a second coil segment is moved outward in the radial direction after being arranged inside the stator core and is inserted into an inner diameter side of the slot. Then, one end portions of the first and second coil segments protruding from an end face of the stator core are joined to each other, and the other end portions of the first and second coil segments protruding from an end face of the stator core are joined to each other.

### CROSS-REFERENCE TO RELATED APPLICATION

The present application claims the benefit of priority of Japanese Patent Application No. 2017-134844, filed on Jul. 10, 2017, the content of which is incorporated herein by reference.

### BACKGROUND

### 1. Field of the Invention

The present invention relates a stator for a rotary electric machine to be installed in, for example, an electric vehicle or a hybrid vehicle.

### 2. Description of the Related Art

A stator for a rotary electric machine including a stator core and a coil made of winding wires wound around a teeth of the stator core is known.

Since such a winding type stator has a configuration in which winding wires are wound while holding insulation paper, a winding process is complicated and the winding shaping is difficult.

In view of the above, a stator for a rotary electric machine is proposed in WO 2015/151200 in which a coil includes a plurality of slot coils inserted into slots of a stator core and a plurality of connection coils that connect the plurality of slot coils in a position lying further axially outwards than an axial end face of the stator core.

In addition, JP-A-2000-228852 proposes a vehicle AC generator including a coil formed by joining end portions of a plurality of cranked-shaped conductors inserted into slots of a stator core.

In each of the stators disclosed in WO 2015/151200 and JP-A-2000-228852, the plurality of coil segments are joined to each other in the circumferential direction, and thus the coil is formed.

However, no specific manufacturing method of assembling the coil segments into the slots of the stator core is disclosed.

### SUMMARY

The invention has been made in view of the above circumstance, and an object thereof is to provide a method of manufacturing a stator for a rotary electric machine that can easily form the stator using coil segments.

According to a first aspect of the invention, there is provided a method of manufacturing a stator for a rotary electric machine including: a stator core; and a coil including a plurality of coil segments inserted respectively into a plurality of slots formed in a circumferential direction at an inner periphery of the stator core and protruding outward in an axial direction of the stator core from the slots, the plurality of coil segments including a plurality of first coil segments inserted respectively into the plurality of slots and a plurality of second coil segments inserted respectively into the plurality of slots, the first coil segments including one end portions that are joined to one end portions of the second coil segments inserted into the another slots located at a position apart in one circumferential direction of the stator core from the slots into which the first coil segments, the first coil segments including the other end portions that are joined to the other end portions of the second coil segments inserted into the further another slots located at a position apart in the other circumferential direction of the stator core from the slots into which the first coil segments, the method including: a first step in which the plurality of first coil segments are disposed inside the stator core, the first coil segments disposed inside the stator core are moved in a radial direction of the stator core, and the first coil segments are inserted into outer diameter sides of the slots corresponding to the first coil segments; a second step in which, after the first step, the plurality of second coil segments are disposed inside the stator core, the second coil segments disposed inside the stator core are moved in the radial direction of the stator core, and the second coil segments are inserted into inner diameter sides of the slots corresponding to the second coil segments; and a third step in which, after the second step, the one end portions of the first coil segments and the second coil segments, protruding outward in an axial direction of the stator core from one end face in the axial direction of the stator core, are joined to each other, and the other end portions of the first coil segments and the second coil segments, protruding outward in the axial direction from the one end face in the axial direction of the stator core, are joined to each other.

According to a second aspect of the invention, in the method of the stator for the rotary electric machine according to the first aspect, the first step includes steps of: dividing the first coil segments into N groups, the N being a natural number of 2 or more; and disposing the first coil segments, which are divided inside the stator core, moving the first coil segments disposed inside the stator core in the radial direction of the stator core; and inserting the first coil segments into the outer diameter sides of the slots corresponding to the first coil segments, the steps being sequentially performed for each of the N groups, and the second step includes steps of: dividing the second coil segments into M groups, the M being a natural number of 2 or more; and disposing the second coil segments inside the stator core, moving the M groups of the second coil segments disposed inside the stator core in the radial direction of the stator core, and inserting the second coil segments into the inner diameter sides of the slots corresponding to the second coil segments, the steps being sequentially performed for each of the M groups.

According to a third aspect of the invention, in the method of the stator for the rotary electric machine according to the first aspect or the second aspect, each of the first coil segments includes an insertion portion that is inserted into the slot, a first protrusion portion that protrudes outward in the axial direction of the stator core from the one end face, and a second protrusion portion that protrudes outward in the axial direction of the stator core from the other end face, each of the second coil segments includes an insertion portion that is inserted into the slot, a third protrusion portion that protrudes outward in the axial direction of the stator core from the one end face, and a fourth protrusion portion that protrudes outward in the axial direction of the stator core from the other end face, after the first step and the second step are completed: the end portion of the first protrusion portion of one first coil segment is abutted against the end portion of the third protrusion portion of one second protrusion portion; and the end portion of the second protrusion portion of the one first coil segment is abutted against the end portion of the fourth protrusion portion of a second coil segment different from the one second coil segment, abutting surfaces, between the first protrusion portion of one first coil segment and the third protrusion portion of one second protrusion portion, include: first joining surfaces joined to each other; and bent surfaces that are continuous to the first joining surfaces and are bent with respect to the first joining surfaces, abutting surfaces, between the second protrusion portion of the one first coil segment and the fourth protrusion portion of the second coil segment different from the one second coil segment, include: second joining surfaces joined to each other; and bent surfaces that are continuous to the second joining surfaces and are bent with respect to the second joining surfaces, and in the third step, the first joining surfaces are welded to each other with a laser so that the one first coil segment is joined to the one second coil segment, and the second joining surfaces are welded to each other with a laser so that the one first coil segment is joined to the second coil segment different from the one second coil segment.

According to the first aspect of the invention, by a simple operation of merely performing the step of joining the end portion of the first coil segment to the end portion of the second coil segment after the step of moving the first coil segment after disposing the first coil segment inside the stator core and inserting the first coil segment into the slot and the step of moving the second coil segment after the second coil segment inside the stator core and inserting the second coil segment into the slot, the stator can be easily manufactured. For this reason, it is possible to reduce manufacturing costs.

According to the second aspect of the invention, the first and second coil segments can be inserted without troubles into the slots that are densely arranged in the circumferential direction.

According to the third aspect of the invention, when the abutting surfaces between the end portions of the first coil segments and the end portions of the second coil segments are welded to each other with the laser, since the laser beam is blocked by the bent surfaces, it is possible to prevent the influence of the laser beam on portions other than welding target portions.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a perspective view of a stator for a rotary electric machine as an embodiment of the invention;

FIG. 2 is a perspective view of a first coil segment in the stator illustrated in FIG. 1;

FIG. 3A is a side view of one end portion of the first coil segment illustrated in FIG. 2, and FIG. 3B is a side view of the other end portion of the first coil segment illustrated in FIG. 2;

FIG. 4 is a perspective view of a second coil segment in the stator illustrated in FIG. 1;

FIG. 5A is a side view of one end portion of the second coil segment illustrated in FIG. 4, and FIG. 5B is a side view of the other end portion of the second coil segment illustrated in FIG. 4;

FIG. 6 is a development view of a part of the stator illustrated in FIG. 1 as seen from a radially outer side of a stator core;

FIG. 7 is a perspective view of the vicinity of a joining portion of the first coil segment and the second coil segment illustrated in FIG. 6 as seen from an end face side of the stator core;

FIG. 8 is a cross-sectional view taken along a line VIII-VIII illustrated in FIG. 7;

FIG. 9 is a perspective view illustrating a modified example of the first coil segment in the stator illustrated in FIG. 1

FIG. 10 is a perspective view illustrating a modified example of the second coil segment in the stator illustrated in FIG. 1;

FIG. 11 is a perspective view of a joining portion between a first coil segment of the modified example illustrated in FIG. 9 and a second coil segment of the modified example illustrated in FIG. 10 as seen from the end face side of the stator core;

FIG. 12 is a view seen in a direction of an arrow A of FIG. 11 which illustrates the joining portion between the first coil segment and the second coil segment illustrated in FIG. 11 as seen from a radially inner side of the stator core toward a radially outer side;

FIG. 13 is a view illustrating a manufacturing process of the stator illustrated in FIG. 1;

FIG. 14 is a view illustrating a manufacturing process of the stator subsequent to FIG. 13;

FIG. 15 is a view illustrating a manufacturing process of the stator subsequent to FIG. 14;

FIG. 16 is a view illustrating a manufacturing process of the stator subsequent to FIG. 15;

FIG. 17 is a view illustrating a manufacturing process of the stator subsequent to FIG. 16;

FIG. 18 is a view illustrating a manufacturing process of the stator subsequent to FIG. 17;

FIG. 19 is a view illustrating a manufacturing process of the stator subsequent to FIG. 18;

FIG. 20 is a view illustrating a manufacturing process of the stator subsequent to FIG. 19;

FIG. 21 is a view illustrating a manufacturing process of the stator subsequent to FIG. 20; and

FIG. 22 is a view illustrating a manufacturing process of the stator subsequent to FIG. 21.

### DETAILED DESCRIPTION OF THE INVENTION

Hereinafter, embodiments of the invention will be described with reference to accompanying drawings.

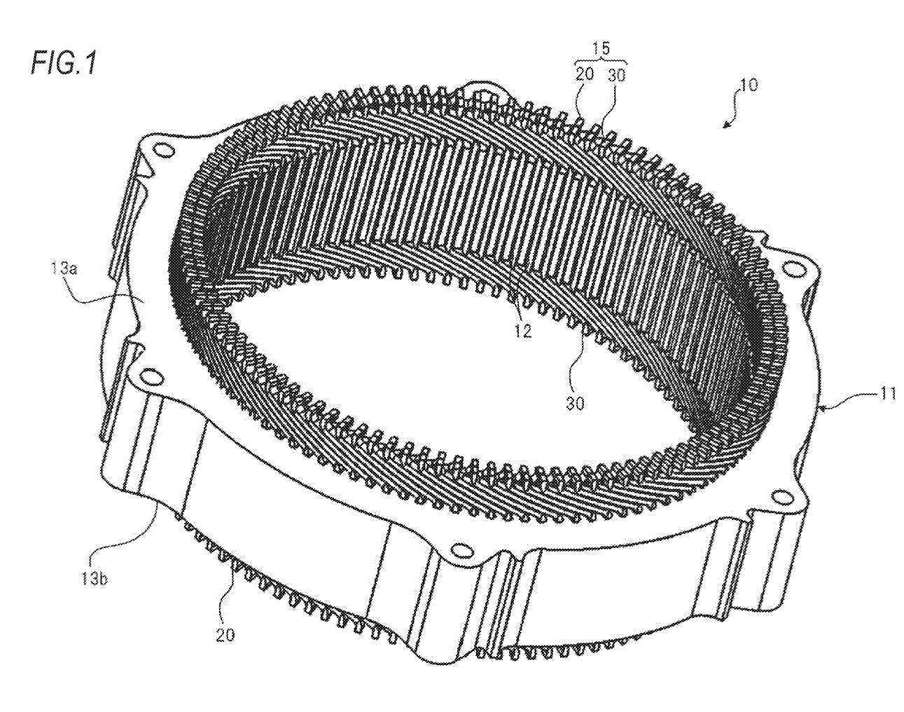

FIG. 1 is a perspective view of a stator 10 for a rotary electric machine according to an embodiment of the invention.

As illustrated in FIG. 1, the stator 10 for the rotary electric machine includes a stator core 11 and a coil 15.

The stator core 11 is, for example, an annular member constituted by laminating a plurality of annular magnetic steel plates. In the stator core 11, a plurality of slots 12 (108 slots in an example of FIG. 1) arranged at regular intervals along a circumferential direction of the stator core 11 is provided on an inner peripheral surface.

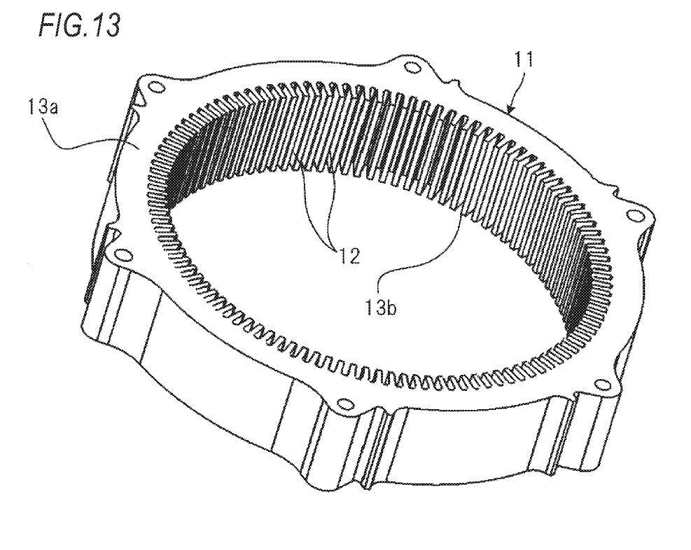

The slot 12 is constituted by a groove extending from one end face 13a in an axial direction of the stator core 11 to the other end face 13b in the axial direction of the stator core 11 (see FIG. 13).

The coil 15 includes a plurality of coil segments inserted into each of a plurality of slots 12 formed in the stator core 11 and protruding outward in the axial direction of the stator core 11 from each slot 12.

The plurality of coil segments are constituted by a plurality of first coil segments 20 (108 first coil segments in the example of FIG. 1) and a plurality of second coil segments 30 (108 second coil segments in the example of FIG. 1).

The first coil segment 20 is inserted into an outer diameter side of each slot 12 of the stator core 11. The second coil segment 30 is inserted into an inner diameter side of each slot 12 of the stator core 11.

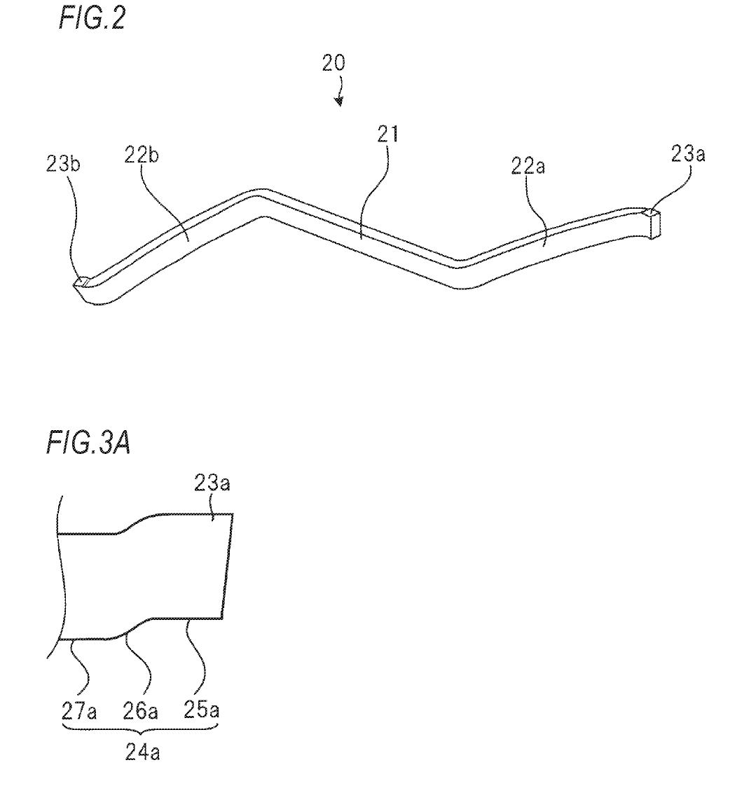

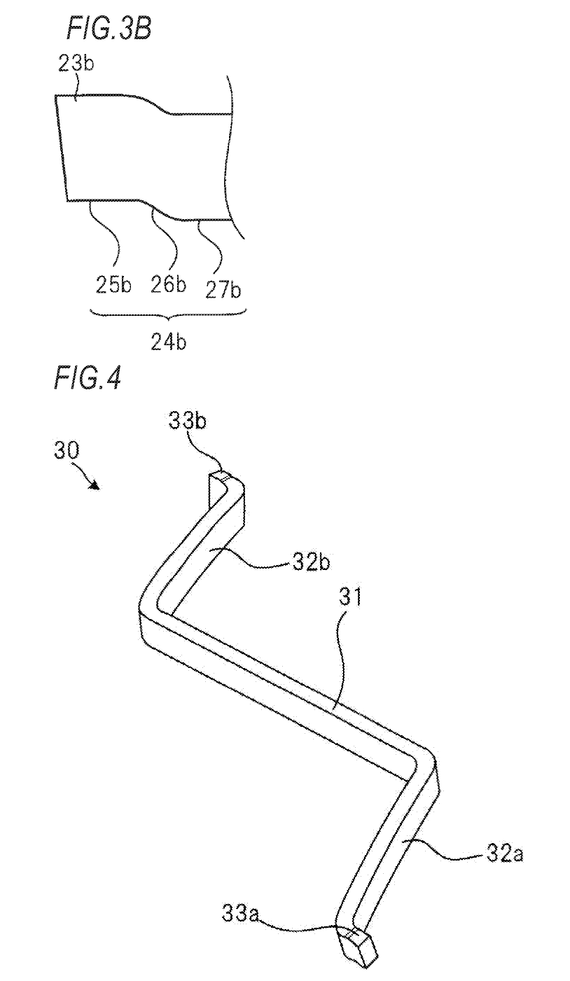

FIG. 2 is a perspective view of the first coil segment 20 in the stator 10 illustrated in FIG. 1. FIG. 3A is a side view of one end portion of the first coil segment 20 illustrated in FIG. 2, and FIG. 3B is a side view of the other end portion of the first coil segment 20 illustrated in FIG. 2.

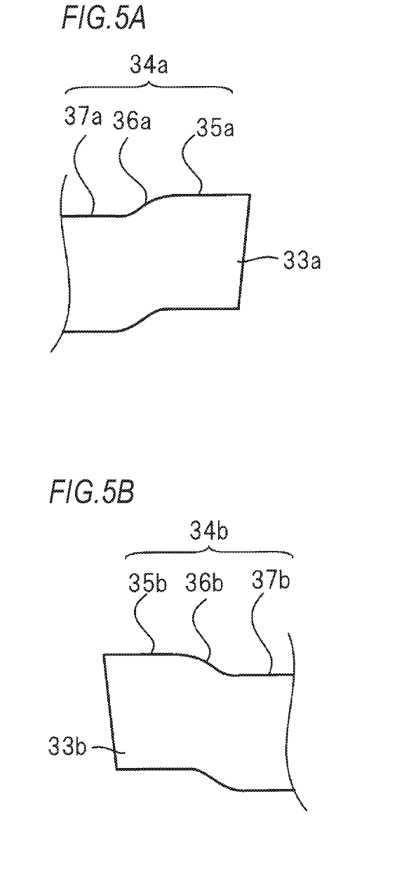

FIG. 4 is a perspective view of the second coil segment 30 in the stator 10 illustrated in FIG. 1. FIG. 5A is a side view of one end portion of the second coil segment 30 illustrated in FIG. 4, and FIG. 5B is a side view of the other end portion of the second coil segment 30 illustrated in FIG. 4.

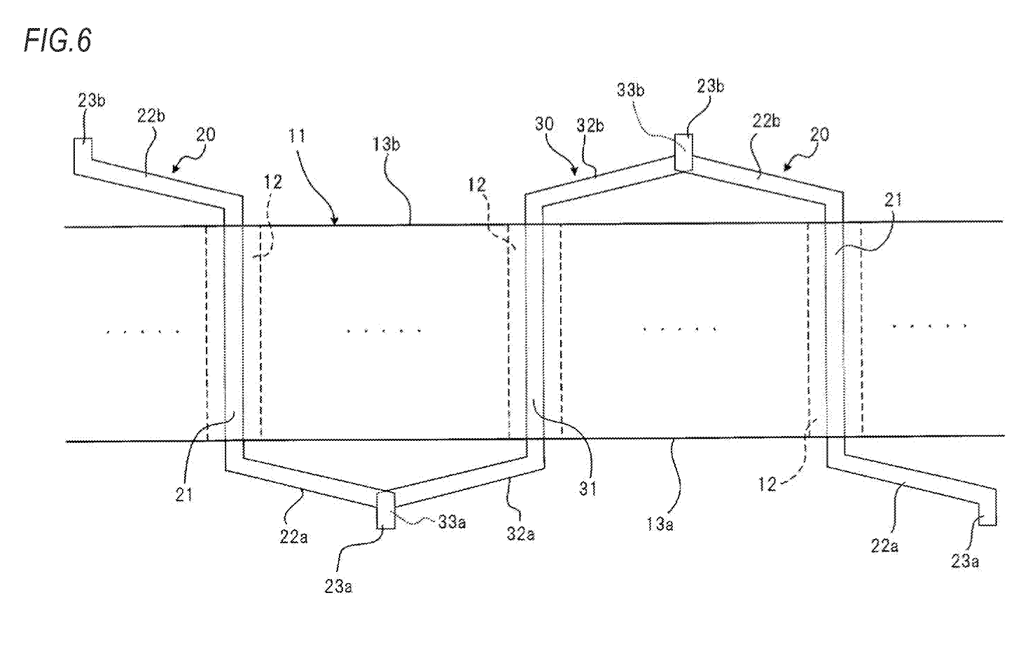

FIG. 6 is a development view of a part of the stator 10 as seen from a radially outer side of the stator core 11. In FIG. 6, in relation to the coil 15, only the first coil segment 20 and the second coil segment 30 which are electrically connected are extracted and illustrated for ease of understanding.

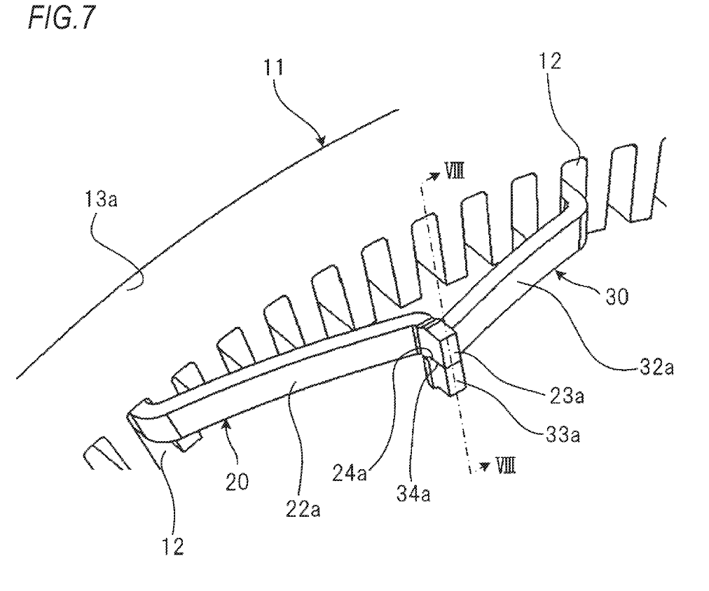

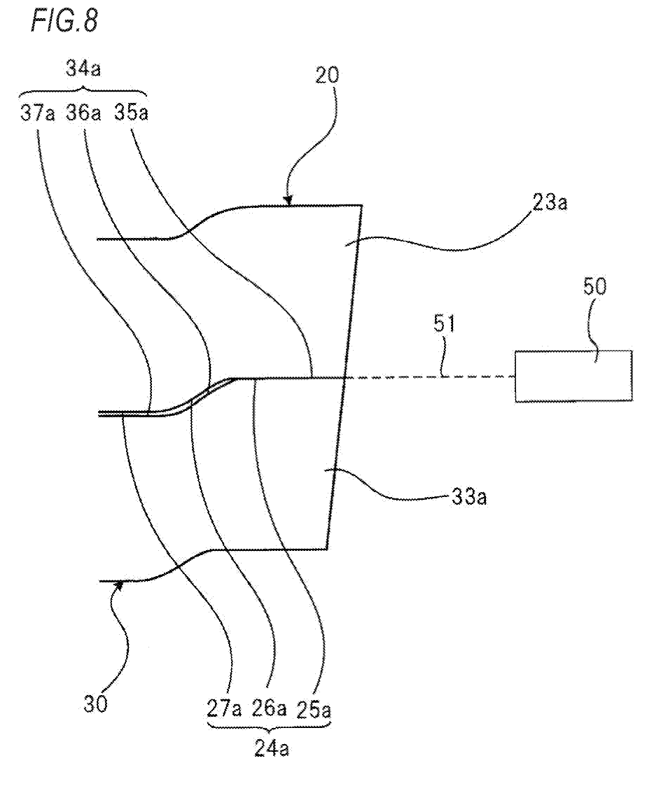

FIG. 7 is a perspective view of the vicinity of a joining portion of the first coil segment 20 and the second coil segment 30 illustrated in FIG. 6 as seen from an end face 13a side of the stator core 11. FIG. 8 is a cross-sectional view taken along a line VIII-VIII illustrated in FIG. 7.

As illustrated in FIGS. 2 and 6, the first coil segment 20 is, for example, a member having a substantially rectangular cross section and a substantially crank shape formed by wire-processing a copper wire. The first coil segment 20 is a so-called magnet wire and is constituted by a conductor and an insulating coating covering the conductor.

The first coil segment 20 includes an insertion portion 21 which has a linear shape and is inserted in the slot 12, a first protrusion portion 22a which protrudes, from one end of the insertion portion 21, further on the outer side than the end face 13a of the stator core 11 in the axial direction of the stator core 11, and a second protrusion portion 22b which protrudes, from the other end of the insertion portion 21, further on the outer side than an end face 13b of the stator core 11 in the axial direction.

The first protrusion portion 22a extends in a right direction in FIG. 6 along a circumferential direction of the stator core 11. The second protrusion portion 22b extends along the circumferential direction of the stator core 11 in a direction (left direction in FIG. 6) opposite to the first protrusion portion 22a.

An end portion 23a of the first protrusion portion 22a is bent in a direction intersecting the extending direction of the first protrusion portion 22a so as to be substantially parallel to the insertion portion 21. As illustrated in FIGS. 3A and 8, the end portion 23a of the first protrusion portion 22a has a stepped shape which is lifted up toward a radially outer side of the stator core 11 by press-molding.

An end portion 23b of the second protrusion portion 22b is bent in a direction intersecting the extending direction of the second protrusion portion 22b so as to be substantially parallel to the insertion portion 21. As illustrated in FIG. 3B, the end portion 23b of the second protrusion portion 22b has a stepped shape which is lifted up toward the radially outer side of the stator core 11 by press-molding.

As illustrated in FIGS. 4 and 6, the second coil segment 30 is, for example, a member having a substantially rectangular cross section and a substantially crank shape formed by wire-processing a copper wire. The second coil segment 30 is a so-called magnet wire and is constituted by a conductor and an insulating coating covering the conductor.

The second coil segment 30 includes an insertion portion 31 which is inserted in the slot 12, a third protrusion portion 32a which protrudes further on the outer side than the end face 13a of the stator core 11 in the axial direction of the stator core 11, and a fourth protrusion portion 32b which protrudes further on the outer side than the end face 13b of the stator core 1 in the axial direction.

The third protrusion portion 32a extends in a left direction in FIG. 6 along the circumferential direction of the stator core 11. The fourth protrusion portion 32b extends along the circumferential direction of the stator core 11 in a direction (right direction in FIG. 6) opposite to the third protrusion portion 32a.

An end portion 33a of the third protrusion portion 32a is bent in a direction intersecting the extending direction of the third protrusion portion 32a so as to be substantially parallel to the insertion portion 31. As illustrated in FIGS. 5A and 8, the end portion 33a of the third protrusion portion 32a has a stepped shape which is lifted up toward a radially outer side of the stator core 11 by press-molding.

An end portion 33b of the fourth protrusion portion 32b is bent in a direction intersecting the extending direction of the fourth protrusion portion 32b so as to be substantially parallel to the insertion portion 31. As illustrated in FIG. 5B, the end portion 33b of the fourth protrusion portion 32b has a stepped shape which is lifted up toward the radially outer side of the stator core 11 by press-molding.

As illustrated in FIGS. 6 and 7, the end portion 23a of the first coil segment 20 is joined to the end portion 33a of the second coil segment 30 which is inserted into another slot 12 at a position (more specifically, the position shifted clockwise from the insertion slot by nine slots, when viewed from the end face 13a side) apart in one circumferential direction of the stator core 11 with respect to the slot 12 (hereinafter, also referred to as an insertion slot) into which the first coil segment 20 is inserted. “Joining” means that the insulating coating covering the conductor melts and the conductors are electrically connected to each other.

Further, the end portion 23b of the first coil segment 20 is joined to the end portion 33b of the second coil segment 30 which is inserted into still another slot 12 at a position (more specifically, the position shifted counterclockwise from the insertion slot by nine slots, when viewed from the end face 13a side) apart in the other circumferential direction of the stator core 11 with respect to the insertion slot.

In this way, the joining of the end portion 23a of the first coil segment 20 and the end portion 33a of the second coil segment 30 and the joining of the end portion 23b of the first coil segment 20 and the end portion 33b of the second coil segment 30 are repeated, in such a manner that a coil loop is formed.

The coil 15 has a plurality of coil loops and those plural coil loops are selectively connected to constitute a power line of a plurality of phases (for example, a U phase, a V phase, and a W phase).

As illustrated in FIG. 7, the end portion 23a of the first coil segment 20 is joined to the end portion 33a by laser-welding in a state where the end portion 23a abuts on the end portion 33a of the second coil segment 30.

More specifically, in the end portion 23a of the first coil segment 20 and the end portion 33a of the second coil segment 30, an abutting surface 24a which faces radially inward of the end portion 23a of the first coil segment 20 and an abutting surface 34a which faces radially outward of the end portion 33a of the second coil segment 30 overlap in the radial direction of the stator core 11 and, in this state, a part of the abutting surface 24a and a part of the abutting surface 34a are joined together.

Similarly, the end portion 23b of the first coil segment 20 is joined to the end portion 33b by laser-welding in a state where the end portion 23b abuts on the end portion 33b of the second coil segment 30.

More specifically, in the end portion 23b of the first coil segment 20 and the end portion 33b of the second coil segment 30, an abutting surface 24b which faces radially inward of the end portion 23b of the first coil segment 20 and an abutting surface 34b which faces radially outward of the end portion 33b of the second coil segment 30 overlap in the radial direction of the stator core 11 and, in this state, a part of the abutting surface 24b and a part of the abutting surface 34b are joined together.

As illustrated in FIG. 3A, in the end portion 23a of the first coil segment 20, the abutting surface 24a abutting on the end portion 33a of the second coil segment 30 is constituted by a joining surface 25a, a bent surface 26a and a flat surface 27a.

The joining surface 25a is a surface which extends in the circumferential direction and the axial direction and is joined to the end portion 33a of the second coil segment 30 by laser-welding.

The bent surface 26a is a surface continuous with the joining surface 25a and is a surface bent toward the radially inner side of the stator core 11 with respect to the joining surface 25a.

The flat surface 27a is continuous with the bent surface 26a and substantially parallel to the joining surface 25a.

As illustrated in FIG. 5A, in the end portion 33a of the second coil segment 30, the abutting surface 34a abutting on the end portion 23a of the first coil segment 20 is constituted by a joining surface 35a, a bent surface 36a and a flat surface 37a.

The joining surface 35a is a surface which extends in the circumferential direction and the axial direction and is joined to the end portion 23a of the first coil segment 20 by laser-welding.

The bent surface 36a is a surface continuous with the joining surface 35a and is a surface bent toward the radially inner side of the stator core 11 with respect to the joining surface 35a.

The flat surface 37a is continuous with the bent surface 36a and substantially parallel to the joining surface 35a.

As illustrated in FIG. 3B, in the end portion 23b of the first coil segment 20, the abutting surface 24b abutting on the end portion 33b of the second coil segment 30 is constituted by a joining surface 25b, a bent surface 26b and a flat surface 27b.

The joining surface 25b is a surface which extends in the circumferential direction and the axial direction and is joined to the end portion 33b of the second coil segment 30 by laser-welding.

The bent surface 26b is a surface continuous with the joining surface 25b and is a surface bent toward the radially inner side of the stator core 11 with respect to the joining surface 25b.

The flat surface 27b is continuous with the bent surface 26b and substantially parallel to the joining surface 25b.

As illustrated in FIG. 5B, in the end portion 33b of the second coil segment 30, the abutting surface 34b abutting on the end portion 23b of the first coil segment 20 is constituted by a joining surface 35b, a bent surface 36b and a flat surface 37b.

The joining surface 35b is a surface which extends in the circumferential direction and the axial direction and is joined to the end portion 23b of the first coil segment 20 by laser-welding.

The bent surface 36b is a surface continuous with the joining surface 35b and is a surface bent toward the radially inner side of the stator core 11 with respect to the joining surface 35b.

The flat surface 37b is continuous with the bent surface 36b and substantially parallel to the joining surface 35b.

In the stator 10 configured as described above, the flat surfaces of the joining surface 25a and the joining surface 35a are brought into contact with each other in a state where the end portion 23a of the first coil segment 20 and the end portion 33a of the second coil segment 30 are overlapped.

In this state, as illustrated in FIG. 8, a laser irradiation device 50 which is located on a side opposite to the end face 13a of the stator core 11 with the end portion 23a of the first coil segment 20 and the end portion 33a of the second coil segment 30 interposed therebetween irradiates the laser beam 51 toward the end face 13a of the stator core 11 along the interface between the joining surface 25a and the joining surface 35a, in such a manner that the joining surface 25a and the joining surface 35a are welded.

In the stator 10, as illustrated in FIG. 8, the bent surface 26a continuous with the joining surface 25a is bent inward in the radial direction with respect to the joining surface 25a and the bent surface 36a continuous with the joining surface 35a is bent inward in the radial direction with respect to the joining surface 35a.

Therefore, the laser beam 51 which is irradiated from the laser irradiation device 50 and passes through the interface between the joining surface 25a and the joining surface 35a is blocked by the bent surface 26a and the laser beam 51 does not reach further on the stator core 11 side than the abutting surfaces 24a and 34a.

As described above, even when the laser beam 51 passes through the interface between the joining surface 25a and the joining surface 35a, the laser beam 51 is irradiated only on the insulating coating on the surface of the bent surface 26a. Even when the insulation coating is peeled off, there is no influence on the performance as the coil 15 because it is necessary to electrically connect the end portion 23a and the end portion 33a.

As described above, according to the stator 10, it is possible to prevent the laser beam from being irradiated to portions other than the abutting surfaces 24a and 34a which are welding target portions when the abutting surfaces between the first coil segment 20 and the second coil segment 30 are subjected to laser-welding. Therefore, it is possible to prevent the performance of the stator 10 from being degraded by the laser welding.

Similarly, in the case of a joint portion between the end portion 23b of the first coil segment 20 and the end portion 33b of the second coil segment 30, it is possible to prevent the laser beam from being irradiated to portions other than the abutting surfaces 24b and 34b which are welding target portions when the abutting surfaces 24b and 34b are welded with the laser.

According to the stator 10, the abutting surface 24a (24b) of the first coil segment 20 and the abutting surface 34a (34b) of the second coil segment 30 are overlapped in the radial direction merely by inserting the first coil segment 20 and the second coil segment 30 into the slots 12 of the stator core 11.

Therefore, after the coil segments are attached to the stator core 11, it is possible to complete the coil 15 only by laser-welding. This eliminates the need for dedicated equipment for twist-bending the coil segments and the like, and thus the manufacturing cost can be reduced.

Further, according to the stator 10, welding spots necessary for forming the coil loop are only the end portions of the first coil segment 20 and the second coil segment 30. Therefore, it is possible to reduce the welding spots and reduce the manufacturing cost.

In addition, according to the stator 10, the end portions of the first coil segment 20 and the second coil segment 30 are respectively molded by press working at the stage of components, in such a manner that the process subsequent to the attachment of the coil segments to the stator core 11 can be simplified. Therefore, it is possible to reduce the manufacturing cost.

The configuration of the first coil segment 20 and the second coil segment 30 in the stator 10 illustrated in FIG. 1 can be modified as follows.

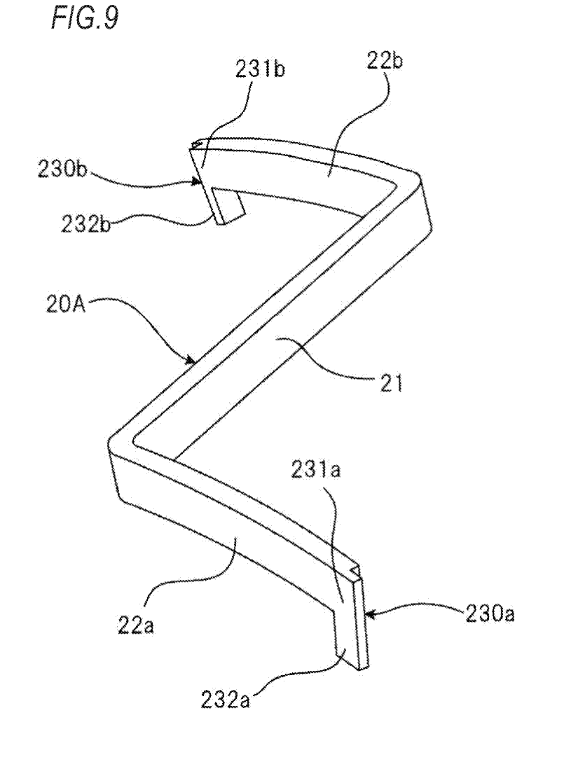

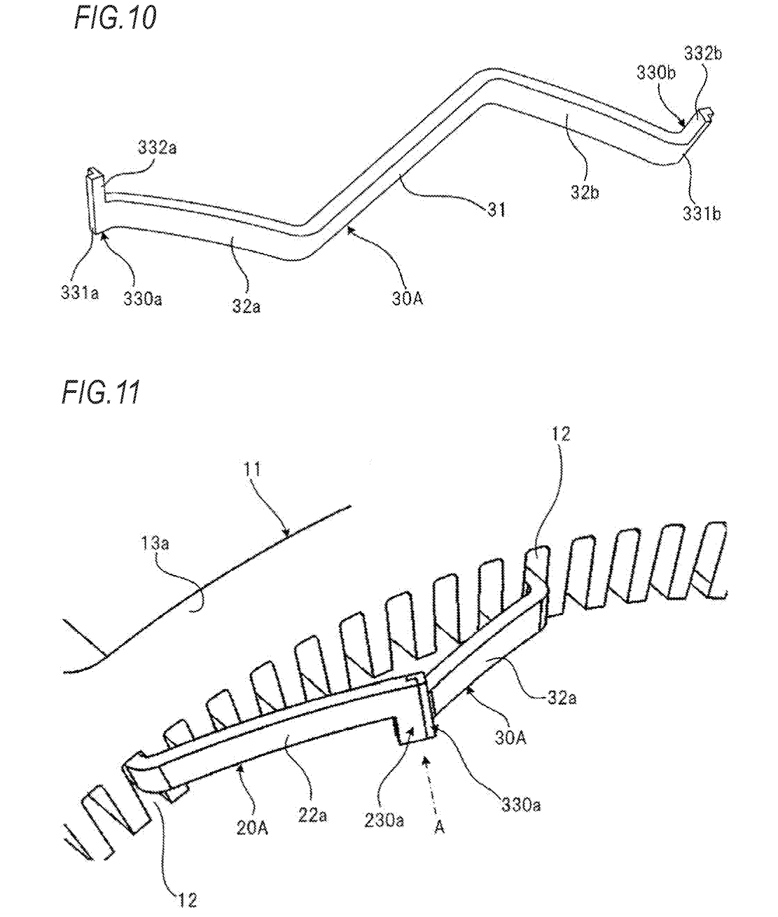

FIG. 9 is a perspective view illustrating a modified example of the first coil segment 20 in the stator 10 illustrated in FIG. 1. FIG. 10 is a perspective view illustrating a modified example of the second coil segment 30 in the stator 10 illustrated in FIG. 1.

FIG. 11 is a perspective view of a joining portion between a first coil segment 20A of the modified example illustrated in FIG. 9 and a second coil segment 30A of the modified example illustrated in FIG. 10 as seen from the end face 13a side of the stator core 11.

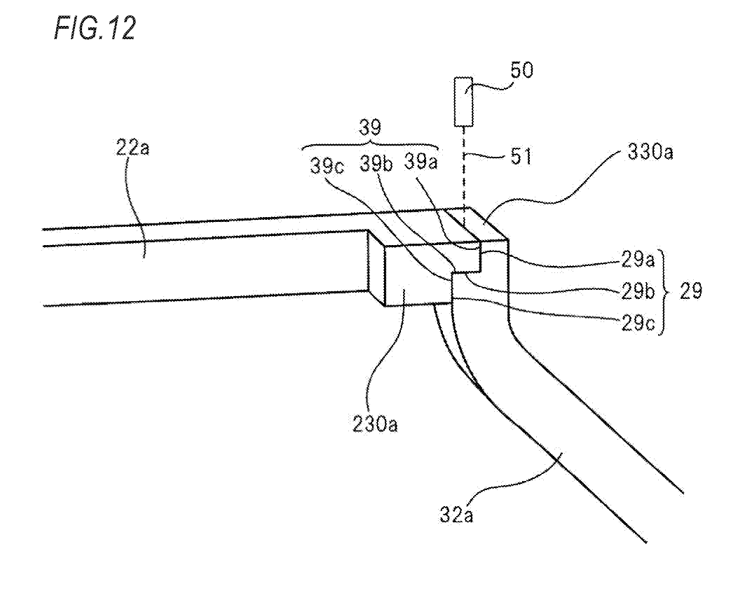

FIG. 12 is a view seen in a direction of an arrow A of FIG. 11 which illustrates the joining portion between the first coil segment 20A and the second coil segment 30A illustrated in FIG. 11 as seen from a radially inner side of the stator core 11 toward a radially outer side.

The first coil segment 20A has the same configuration as that of the first coil segment 20 except that the shape of the end portion of the first protrusion portion 22a and the shape of the end portion of the second protrusion portion 22b are different.

As illustrated in FIG. 9, an end portion 230a of a first protrusion portion 22a of the first coil segment 20A includes a base portion 231a which has the same width as the other portion of the first protrusion portion 22a and a projection portion 232a which protrudes from the base portion 231 a in a direction (in the example of FIG. 9, the direction toward the radially inner side of the stator core 11) intersecting a direction in which the first protrusion portion 22a extends. The width (radial width) of the end portion 230a is wider than that of the other portion of the first protrusion portion 22a.

The thickness of the tip of the end portion 230a is reduced in the width direction by press working or the like. By the thin portion at the tip, an abutting surface 29 (see FIG. 12) having a stepped shape and a substantially L-shaped cross section is formed in the end portion 230a.

An end portion 230b of a second protrusion portion 22b of the first coil segment 20A includes a base portion 231b which has the same width as the other portion of the second protrusion portion 22b and a projection portion 232b which protrudes from the base portion 231b in a direction (in the example of FIG. 9, the direction toward the radially inner side of the stator core 11) intersecting a direction in which the second protrusion portion 22b extends. The width (radial width) of the end portion 230b is wider than that of the other portion of the second protrusion portion 22b.

The thickness of the tip of the end portion 230b is reduced in the width direction by press working or the like. By the thin portion at the tip, an abutting surface having a stepped shape and a substantially L-shaped cross section is formed in the end portion 230b.

The second coil segment 30A has the same configuration as that of the second coil segment 30 except that the shape of the end portion of the third protrusion portion 32a and the shape of the end portion of the fourth protrusion portion 32b are different.

As illustrated in FIG. 12, the end portion 330a of the third protrusion portion 32a of the second coil segment 30A is bent in a direction (direction away from the end face 13a of the stator core 11) intersecting an extending direction of the third protrusion portion 32a.

As illustrated in FIG. 10, an end portion 330a of a third protrusion portion 32a of the second coil segment 30A includes a base portion 331a which has the same width as the other portion of the third protrusion portion 32a and a projection portion 332a which protrudes from the base portion 331a in a direction (in the example of FIG. 10, the direction toward the radially outer side of the stator core 11) intersecting a direction in which the end portion 330a extends. The width (radial width) of the end portion 330a is wider than that of the other portion of the third protrusion portion 32a.

The thickness of the tip of the end portion 330a is reduced in the width direction by press working or the like. By the thin portion at the tip, an abutting surface 39 (see FIG. 12) having a stepped shape and a substantially L-shaped cross section is formed in the end portion 330a. As illustrated in FIGS. 11 and 12, the end portion 330a of the second coil segment 30A has a shape in which the end portion 330a meshes with the end portion 230a of the first coil segment 20A.

The end portion 330b of the fourth protrusion portion 32b of the second coil segment 30A is bent in a direction (direction away from the end face 13b of the stator core 11) intersecting an extending direction of the fourth protrusion portion 32b.

An end portion 330b of the fourth protrusion portion 32b of the second coil segment 30A includes a base portion 331b which has the same width as the other portion of the fourth protrusion portion 32b and a projection portion 332b which protrudes from the base portion 331b in a direction (in the example of FIG. 10, the direction toward the radially outer side of the stator core 11) intersecting a direction in which the end portion 330b extends. The width (radial width) of the end portion 330b is wider than that of the other portion of the fourth protrusion portion 32b.

The thickness of the tip of the end portion 330b is reduced in the width direction by press working or the like. By the thin portion at the tip, an abutting surface having a stepped shape and a substantially L-shaped cross section is formed in the end portion 330b. The end portion 330b of the second coil segment 30A has a shape in which the end portion 330b meshes with the end portion 230b of the first coil segment 20A.

As illustrated in FIG. 11, the end portion 230a of the first coil segment 20A is joined to the end portion 330a by laser-welding in a state where the end portion 230a abuts on the end portion 330a of the second coil segment 30A.

More specifically, the end portion 230a of the first coil segment 20A and the end portion 330a of the second coil segment 30A are overlapped in the circumferential direction of the stator core 11 in a state where the abutting surface 29 of the end portion 230a of the first coil segment 20A and the abutting surface 39 of the end portion 330a of the second coil segment 30A are engaged with each other and, in this state, a part of the abutting surface 29 and a part of the abutting surface 39 are joined together.

Similarly, the end portion 230b of the first coil segment 20A is joined to the end portion 330b by laser-welding in a state where the end portion 230b abuts on the end portion 330b of the second coil segment 30A.

More specifically, the end portion 230b of the first coil segment 20A and the end portion 330b of the second coil segment 30A are overlapped in the circumferential direction of the stator core 11 in a state where the abutting surface of the end portion 230b of the first coil segment 20A and the abutting surface of the end portion 330b of the second coil segment 30A are engaged with each other and, in this state, parts of the abutting surfaces are joined together.

As illustrated in FIG. 12, the abutting surface 29 in the end portion 230a of the first coil segment 20A, on which the end portion 330a of the second coil segment 30A abuts, is constituted by a joining surface 29a, a bent surface 29b, and a flat surface 29c.

The joining surface 29a is a surface to be joined to the end portion 330a of the second coil segment 30A by laser-welding.

The bent surface 29b is a surface continuous with the joining surface 29a and is a surface (surface perpendicular to the joining surface 29a in the example of FIG. 12) bent with respect to the joining surface 29a.

The flat surface 29c is a surface continuous with the bent surface 29b and substantially parallel to the joining surface 29a.

The abutting surface 39 in the end portion 330a of the second coil segment 30A, on which the end portion 230a of the first coil segment 20A abuts, is constituted by a joining surface 39a, a bent surface 39b, and a flat surface 39c.

The joining surface 39a is a surface to be joined to the end portion 230a of the first coil segment 20A by laser-welding.

The bent surface 39b is a surface continuous with the joining surface 39a and is a surface (surface perpendicular to the joining surface 39a in the example of FIG. 12) bent with respect to the joining surface 39a.

The flat surface 39c is a surface continuous with the bent surface 39b and substantially parallel to the joining surface 39a.

Similarly, in the case of an abutting surface in the end portion 230b of the first coil segment 20A, on which the end portion 330b of the second coil segment 30A abut, a joining surface joined to the end portion 330b by laser-welding, a bent surface continuous with the joining surface and bent with respect to the joining surface, and a flat surface continuous with the bent surface are provided.

Similarly, in the case of an abutting surface in the end portion 330b of the second coil segment 30A, on which the end portion 230b of the first coil segment 20A abut, a joining surface joined to the end portion 230b by laser-welding, a bent surface continuous with the joining surface and bent with respect to the joining surface, and a flat surface continuous with the bent surface are provided.

In the stator 10 of the modified example configured as described above, the flat surface of the joining surface 29a and the flat surface of the joining surface 39a are brought into contact with each other in a state (abutted state) where the end portion 230a of the first coil segment 20A and the end portion 330a of the second coil segment 30A are engaged with each other.

In this state, as illustrated in FIG. 12, the interface between the joining surface 29a and the joining surface 39a is irradiated with the laser beam 51 from the laser irradiation device 50, in such a manner that the joining surface 29a and the joining surface 39a are welded.

In the stator 10 of the modified example, as illustrated in FIG. 12, the bent surface 29b continuous to the joining surface 29a and the bent surface 39b continuous to the joining surface 39a are bent in the same direction with respect to the joining surface 29a and the joining surface 39a.

Therefore, the laser beam 51 which passes through the interface between the joining surface 29a and the joining surface 39a is blocked by the bent surface 39b and the laser beam 51 does not reach further on the stator core 11 side than the abutting surfaces 29 and 39.

As described above, even when the laser beam 51 passes through the interface between the joining surface 29a and the joining surface 39a, the laser beam 51 is irradiated only on the insulating coating on the surface of the bent surface 39b. Even when the insulation coating is peeled off, there is no influence on the performance as the coil 15 because it is necessary to electrically connect the end portion 230a and the end portion 330a.

As described above, according to the stator 10 of the modified example, it is possible to prevent the laser beam from being irradiated to portions other than the abutting surfaces 29 and 39 which are welding target portions when the abutting surfaces between the first coil segment 20A and the second coil segment 30A are welded with the laser. Therefore, it is possible to prevent the performance of the stator 10 from being degraded by the laser welding.

Similarly, in the case of a joint portion between the end portion 230b of the first coil segment 20A and the end portion 330b of the second coil segment 30, it is possible to prevent the laser beam from being irradiated to portions other than the abutting surfaces which are welding target portions when the abutting surfaces are welded with the laser.

According to the stator 10 of the modified example, the end portions 230a and 230b of the first coil segment 20A and the end portions 330a and 330b of the second coil segment 30A are respectively widened by the projection portions 232a, 232b, 332a, and 332b.

Therefore, the welding length of the welded portion between the first coil segment 20A and the second coil segment 30A can be increased, and thus the electrical resistance can be suppressed.

Other operations and effects are the same as those of the stator 10 for the rotary electric machine described in FIGS. 1 to 8.

Next, a manufacturing method of the stator 10 will be described with reference to FIGS. 13 to 22. The manufacturing method of the stator 10 is common to the stator 10 described with reference to FIGS. 1 to 8 and the stator 10 of the modified example described with reference to FIGS. 9 to 12. Therefore, in the following description, the manufacturing method of the stator 10 for the rotary electric machine explained in FIGS. 1 to 8 will be described.

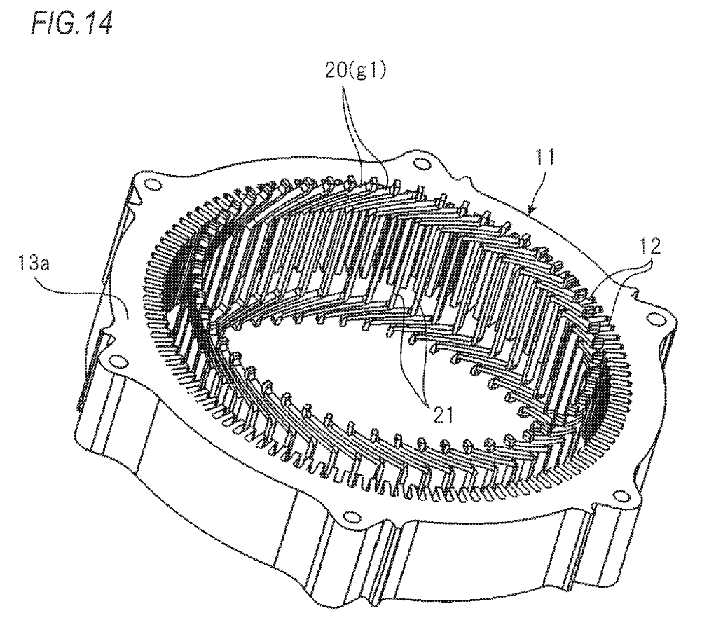

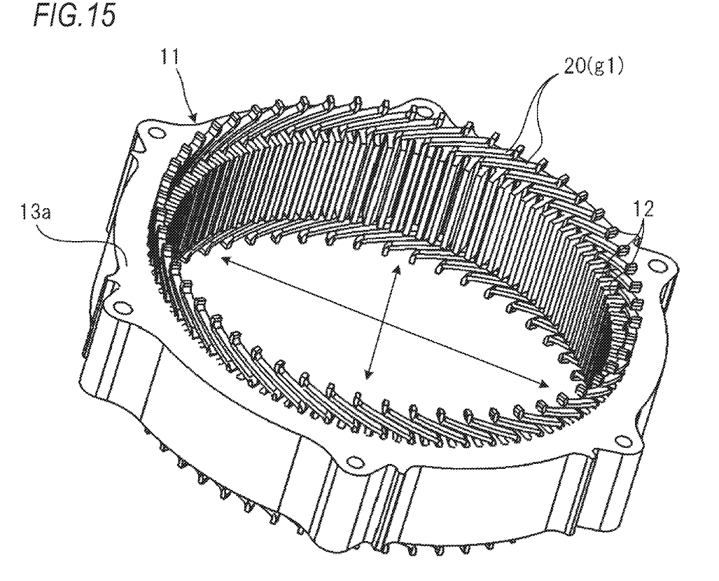

First, as illustrated in FIG. 13, the stator core 11 is fixed at a predetermined position. Next, the entirety of the first coil segments 20 (108 first coil segments in this case) constituting the stator 10 is grouped into two groups of 54 pieces. Then, as illustrated in FIG. 14, the first coil segments 20 (hereinafter, for convenience, reference numerals and letters of “20(g1)” is given thereto) of one of the two groups are arranged inside the stator core 11 so as to correspond to each of the 54 slots 12 arranged alternately in the circumferential direction of the stator core 11.

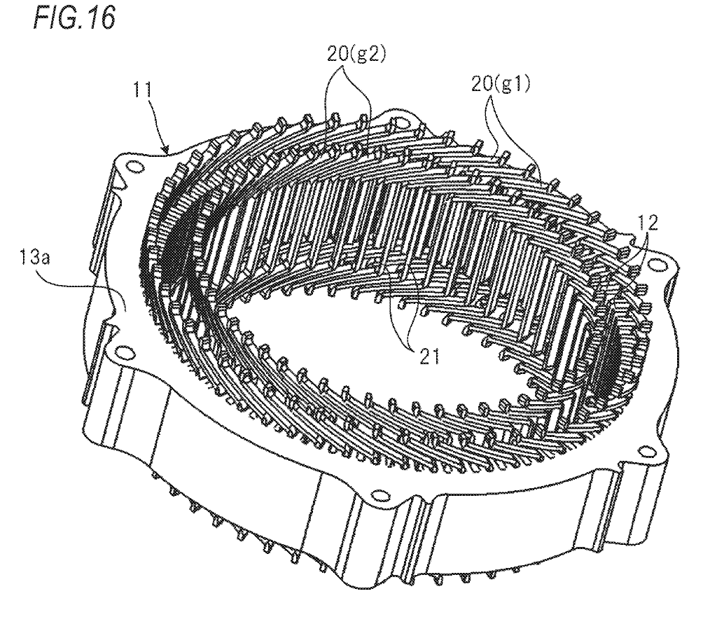

Next, as illustrated in FIG. 15, the 54 first coil segments 20(g1) arranged inside the stator core 11 are uniformly moved in the radial direction of the stator core 11 and the insertion portion 21 of each first coil segment 20(g1) is inserted into the outer diameter side of the slot 12 corresponding thereto.

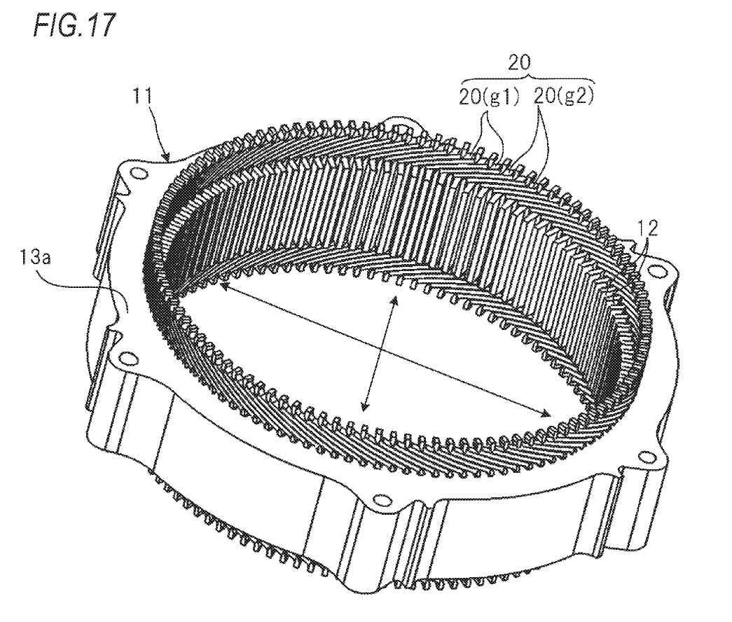

Next, as illustrated in FIG. 16, the first coil segments 20 (hereinafter, for convenience, reference numerals and letters of “20(g2)” is given thereto) of the other of the two groups described above are arranged inside the stator core 11 so as to correspond to each of the 54 slots 12 into which the first coil segments 20(g1) are not inserted.

Next, as illustrated in FIG. 17, the 54 first coil segments 20(g2) arranged inside the stator core 11 are uniformly moved in the radial direction of the stator core 11 and the insertion portion 21 of each first coil segment 20(g2) is inserted into the outer diameter side of the slot 12 corresponding thereto.

In this manner, the first coil segments 20 are divided into two groups and the first coil segments 20 are inserted into the slots 12 for each group. This is because when the entirety of the first coil segments 20 are aligned in the circumferential direction inside the stator core 11, the length in the circumferential direction becomes shorter than that in a state where the first coil segments 20 is inserted in the slots 12, and thus, in the case of the stator core 11 having a narrow interval between the slots 12, interference occurs between the adjacent first coil segments 20, which makes it difficult to arrange the first coil segments 20.

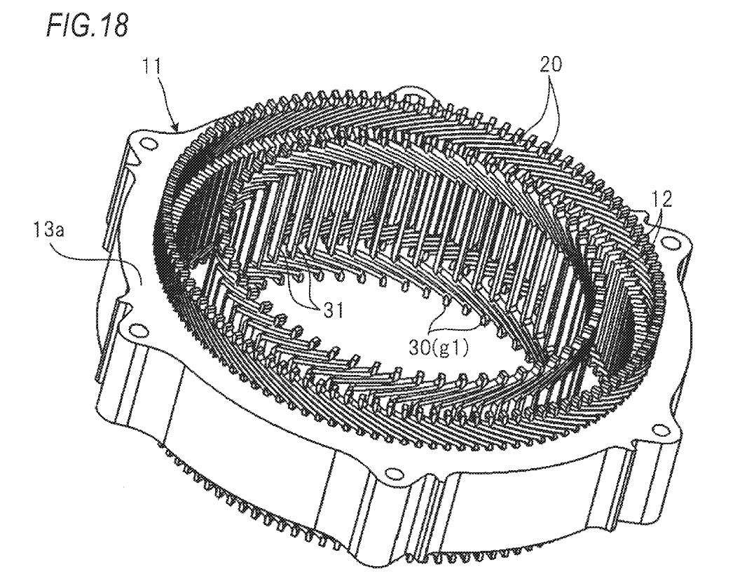

Next, for the same reason as above, the entirety of the second coil segments 30 (108 second coil segments in this case) constituting the stator 10 is grouped into two groups of 54 pieces. Then, as illustrated in FIG. 18, the second coil segments 30 (hereinafter, for convenience, reference numerals and letters of “30(g1)” is given thereto) of one of the two groups are arranged inside the stator core 11 so as to correspond to each of the 54 slots 12 arranged alternately in the circumferential direction of the stator core 11.

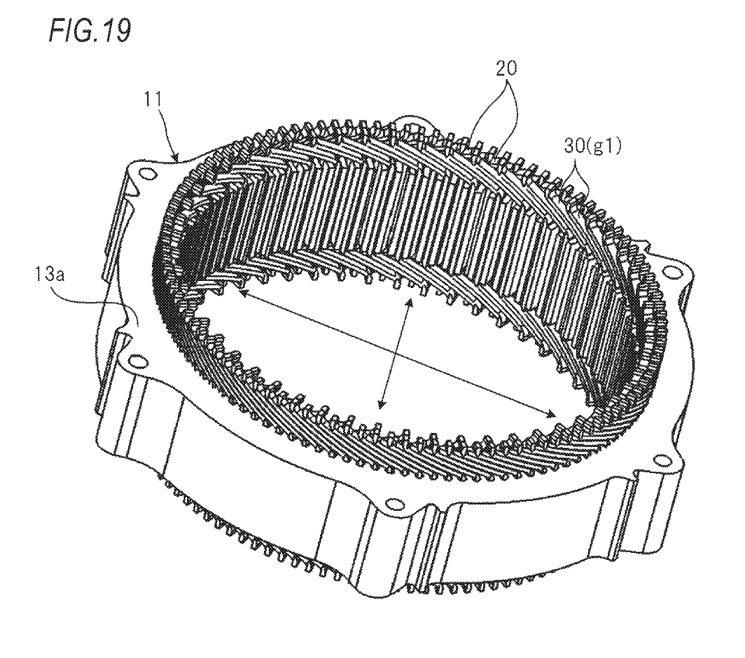

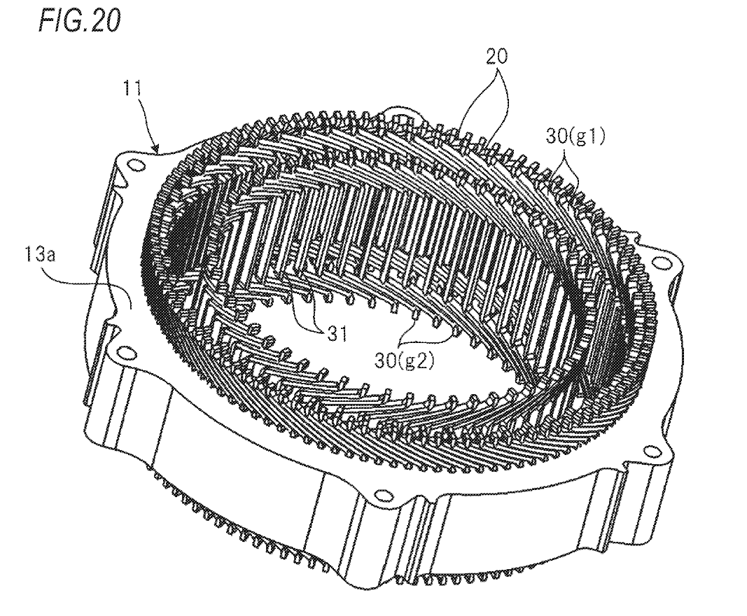

Next, as illustrated in FIG. 19, the 54 second coil segments 30(g1) arranged inside the stator core 11 are uniformly moved in the radial direction of the stator core 11 and the insertion portion 31 of each first coil segment 30(g1) is inserted into the inner diameter side of the slot 12 corresponding thereto.

Therefore, the end portions 23a of the 54 first coil segments 20 respectively abut on the end portions 33a of the second coil segments 30(g1), and thus the end portions 23b of the 54 first coil segments 20 and the end portions 33b of the second coil segments 30(g1) are in an abutted state.

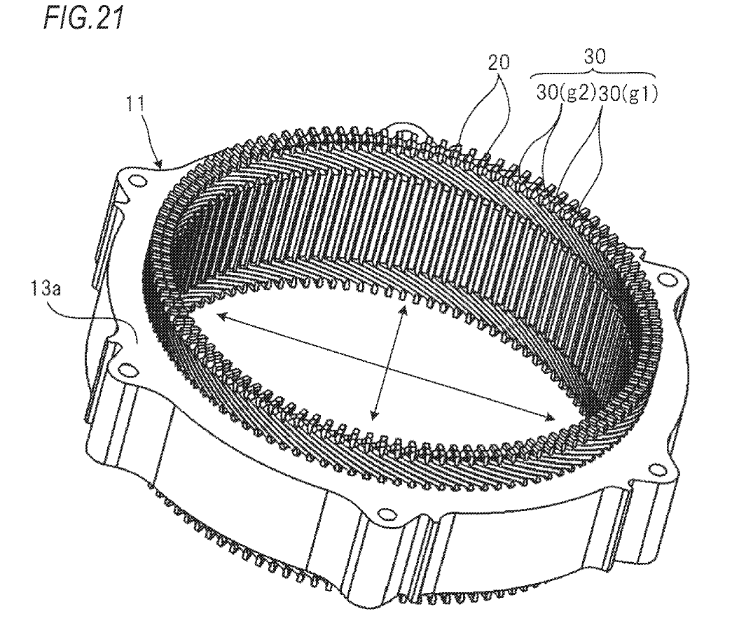

Next, as illustrated in FIG. 20, the second coil segments 30 (hereinafter, for convenience, reference numerals and letters of “30(g2)” is given thereto) of the other of the two groups described above are arranged inside the stator core 11 so as to correspond to each of the 54 slots 12 into which the second coil segments 30(g1) are not inserted.

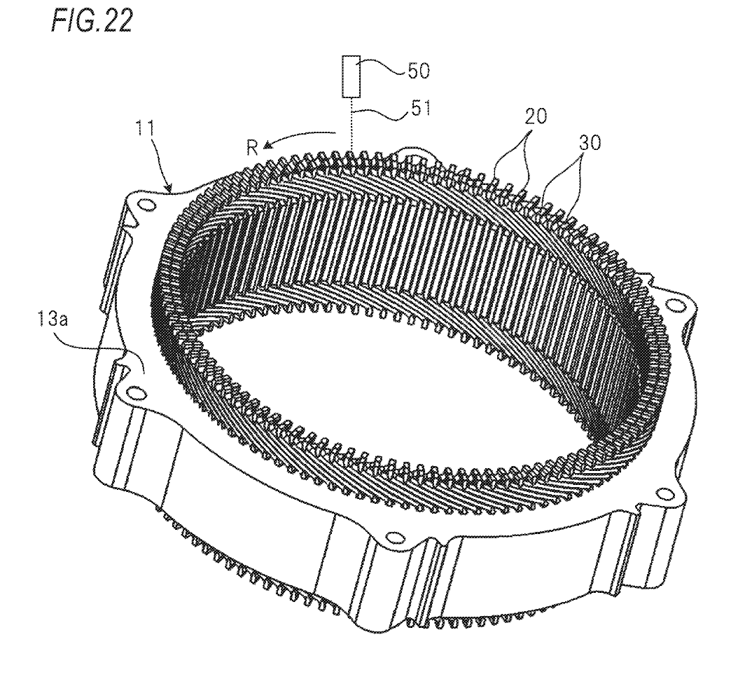

Next, as illustrated in FIG. 21, the 54 second coil segments 30(g2) arranged inside the stator core 11 are uniformly moved in the radial direction of the stator core 11 and the insertion portion 31 of each second coil segment 30(g2) is inserted into the inner diameter side of the slot 12 corresponding thereto.

Therefore, the end portions 23a of the remaining 54 first coil segments 20 respectively abut on the end portions 33a of the second coil segments 30(g2), and thus the end portions 23b of the remaining 54 first coil segments 20 and the end portions 33b of the second coil segments 30(g2) are in an abutted state.

Next, as illustrated in FIG. 22, the laser beam 51 is irradiated from the laser irradiation device 50 which is located on a side opposite to the end face 13a of the stator core 11 with the end portion 23a of the first coil segment 20 and the end portion 33a of the second coil segment 30 interposed therebetween to the interface between the joining surface 25a of the first coil segment 20 described above and the joining surface 35a of the second coil segment 30 which are located further on the outer side than the end face 13a of the stator core 11 in the axial direction, in such a manner that a welding process is performed for welding the interface.

The welding process is sequentially performed while the stator core 11 is rotated in a rotation direction R, in such a manner that the welding of the coil end on one end side of the coil 15 is completed.

The same welding process is also performed on the interface between the joining surface 25b of the first coil segment 20 described above and the joining surface 35b of the second coil segment 30 which are located further on the outer side than the end face 13b of the stator core 11 in the axial direction.

According to the manufacturing method described above, a process of placing the first coil segments 20 inside the stator core 11, moving them, and inserting them into the slots 12, a process of placing the second coil segments 30 inside the stator core 11, moving them, and inserting them into the slots 12, and a process of welding the end portions of the first coil segments 20 and the end portions of the second coil segments 30 are simply performed, in such a simple manner that the stator 10 can be manufactured.

According to the manufacture method described above, it is not necessary to bend the first coil segment 20 and the second coil segment 30 and to process the end portions of the first coil segment 20 and the second coil segment 30 after the first coil segment 20 and the second coil segment 30 are inserted into the slots 12. Therefore, the stator 10 can be easily manufactured.

Further, in the manufacture method described above, the first coil segments 20 are divided into two groups and the process in which the first coil segments 20 are arranged inside the stator core 11 and the arranged first coil segments 20 are radially moved and inserted into the slots 12 is performed for each group, in such a manner that the entirety of the first coil segments 20 are inserted into the slots 12.

In addition, a plurality of the second coil segments 30 are divided into two groups and the process in which the second coil segments 30 are arranged inside the stator core 11 and the arranged second coil segments 30 are radially moved and inserted into the slots 12 is performed for each group, in such a manner that the entirety of the second coil segments 30 are inserted into the slots 12.

Therefore, even in the case of the stator 10 in which the slots 12 are extremely densely arranged, the first coil segments 20 and the second coil segments 30 can be inserted into the slots 12 of the stator core 11 without problems.

In addition, since the coil segments to be inserted into the slots 12 has the structure of the first coil segment 20 and the second coil segment 30 or the first coil segment 20A and the second coil segment 30A, when the end portions of the coil segments are joined by laser-welding, it is possible to prevent the laser beam from being irradiated to a portion other than the welding target portion, that is, a portion other than the abutting surface. Therefore, it is possible to prevent degradation of the performance of stator 10.

The invention is not limited to the embodiments described above and may be appropriately modified, improved, and the like.

For example, in the manufacturing method of the stator 10 described above, the example in which the respective first coil segments 20 and the respective second coil segments 30 are divided into two groups and the coil segments are inserted into the slots 12 of the stator core 11 for each group is described. However, the grouping is not limited to two groups and may be three or more groups.

The number of groups for grouping the first coil segments 20 and the number of groups for grouping the second coil segments 30 do not necessarily have to be the same.

In addition, when the interval between the slots 12 formed in the stator core 11 is wide and the entirety of the first coil segments 20 (second coil segments 30) can be aligned inside the stator core 11, grouping is not essential.

In this case, the entirety of the first coil segments 20 (second coil segments 30) are arranged inside the stator core 11 and the entirety of the arranged first coil segments 20 (second coil segments 30) are uniformly moved in the radial direction, in such a manner that the coil segments may be inserted into the slots 12.

In addition, the shapes of the end portion of the first coil segment 20 and the end portion of the second coil segment 30 are not limited to those described above, and may have a shape in which flat surfaces are brought into contact with each other in an abutting state.

What is claimed is:

1. A method of manufacturing a stator for a rotary electric machine including: a stator core; and a coil including a plurality of coil segments inserted respectively into a plurality of slots formed in a circumferential direction at an inner periphery of the stator core and protruding outward in an axial direction of the stator core from the slots,
the plurality of coil segments including a plurality of first coil segments inserted respectively into the plurality of slots and a plurality of second coil segments inserted respectively into the plurality of slots,
the first coil segments including one end portions that are joined to one end portions of the second coil segments inserted into the another slots located at a position apart in one circumferential direction of the stator core from the slots into which the first coil segments,
the first coil segments including the other end portions that are joined to the other end portions of the second coil segments inserted into the further another slots located at a position apart in the other circumferential direction of the stator core from the slots into which the first coil segments,
the method comprising:
a first step in which the plurality of first coil segments are disposed inside the stator core, the first coil segments disposed inside the stator core are moved in a radial direction of the stator core, and the first coil segments are inserted into outer diameter sides of the slots corresponding to the first coil segments;
a second step in which, after the first step, the plurality of second coil segments are disposed inside the stator core, the second coil segments disposed inside the stator core are moved in the radial direction of the stator core, and the second coil segments are inserted into inner diameter sides of the slots corresponding to the second coil segments; and
a third step in which, after the second step, the one end portions of the first coil segments and the second coil segments, protruding outward in an axial direction of the stator core from one end face in the axial direction of the stator core, are joined to each other, and the other end portions of the first coil segments and the second coil segments, protruding outward in the axial direction from the one end face in the axial direction of the stator core, are joined to each other.

2. The method according to claim 1, wherein:
the first step includes steps of:
dividing the first coil segments into N groups, the N being a natural number of 2 or more; and
disposing the first coil segments, which are divided inside the stator core, moving the first coil segments disposed inside the stator core in the radial direction of the stator core; and inserting the first coil segments into the outer diameter sides of the slots corresponding to the first coil segments, the steps being sequentially performed for each of the N groups; and
the second step includes steps of:
dividing the second coil segments into M groups, the M being a natural number of 2 or more; and
disposing the second coil segments inside the stator core, moving the M groups of the second coil segments disposed inside the stator core in the radial direction of the stator core, and inserting the second coil segments into the inner diameter sides of the slots corresponding to the second coil segments, the steps being sequentially performed for each of the M groups.

3. The method according to claim 1, wherein:
each of the first coil segments includes an insertion portion that is inserted into the slot, a first protrusion portion that protrudes outward in the axial direction of the stator core from the one end face, and a second protrusion portion that protrudes outward in the axial direction of the stator core from the other end face;
each of the second coil segments includes an insertion portion that is inserted into the slot, a third protrusion portion that protrudes outward in the axial direction of the stator core from the one end face, and a fourth protrusion portion that protrudes outward in the axial direction of the stator core from the other end face;
after the first step and the second step are completed:
the end portion of the first protrusion portion of one first coil segment is abutted against the end portion of the third protrusion portion of one second protrusion portion; and
the end portion of the second protrusion portion of the one first coil segment is abutted against the end portion of the fourth protrusion portion of a second coil segment different from the one second coil segment;
abutting surfaces, between the first protrusion portion of one first coil segment and the third protrusion portion of one second protrusion portion, include: first joining surfaces joined to each other; and bent surfaces that are continuous to the first joining surfaces and are bent with respect to the first joining surfaces;
abutting surfaces, between the second protrusion portion of the one first coil segment and the fourth protrusion portion of the second coil segment different from the one second coil segment, include: second joining surfaces joined to each other; and bent surfaces that are continuous to the second joining surfaces and are bent with respect to the second joining surfaces; and
in the third step, the first joining surfaces are welded to each other with a laser so that the one first coil segment is joined to the one second coil segment, and the second joining surfaces are welded to each other with a laser so that the one first coil segment is joined to the second coil segment different from the one second coil segment.
